(19) United States
(12) Patent Application Publication
(10) Pub. No.: US 2006/0005581 A1
(43) Pub. Date: Jan. 12, 2006

(54) Laundry machine

(76) Inventor: Yoshikazu Banba, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/125,332

(22) Filed: May 10, 2005

(30) Foreign Application Priority Data
May 12, 2004 (JP) 2004-142873

(51) Int. Cl. B08B 3/12

(52) U.S. Cl. 68/5 R; 68/19; 68/19.1; 68/23 R; 68/207

(57) ABSTRACT

A drum type laundry machine according to the invention is capable of efficiently supplying steam to laundry in a drum. When the steam is supplied into the drum 11, a blower 39 is rotated at a higher rotation speed than in a heat drying operation (e.g., 5200 rpm) to provide greater air blowing power. Further, a projection 36 provided in an air passage narrows the air passage, so that an air flow rate is increased in the vicinity of a cooling water supply port 34. Therefore, cooling water supplied into a first air passage 32 is finely disintegrated on air, and supplied to a heater 43 in a heater housing 42 through a second air passage 33 and a blower chamber 40. The cooling water is heated by the heater 43 to be evaporated into steam. The steam thus generated is borne on the air and supplied into the drum 11 from a blowing port 44 through an air inlet port 9f.

### BACKGROUND OF THE INVENTION

1. Field of the Invention

The present invention relates to a laundry machine and, more specifically, a laundry machine having a drying function.

2. Description of Related Art

Drum type laundry machines are known which are adapted to perform a laundry process and a drying process for laundry contained in a generally cylindrical drum rotatable about a generally horizontal axis.

One exemplary drum type laundry machine is further adapted to introduce steam into the drum during the drying process to unwrinkle the laundry as disclosed in Japanese Unexamined Patent Publication No. 5-23493 (1993).

In the drum type laundry machine disclosed in this publication, a water container is provided below an outer tub which rotatably supports the drum, and a heater is provided in the water container. Water is contained in the water container, andheatedby the heater for generation of thesteam. Thesteamisintroducedintothedrumthrough drum wall holes (water passage holes through which water is drained during a dewatering step) formed in a circumferential wall of the drum.

The drum type laundry machine is further adapted to heat water retained up to a predetermined water level in the outer tub by the heater in a soaking step and a washing step.

In this drum type laundry machine, however, the efficiency of the introduction of the steam into the drum is not high, because the steam is supplied into the drum through the small water passage holes.

In the drum type laundry machine, air streams generated by the rotation of the drum are heated by the heater, and then introduced into the drum through the drum wall holes for drying the laundry in the drum. Therefore, the efficiency of the drying is not high. A conceivable approach to this is to provide another heater in a drying air passage separately from the heater provided in the water container and use this heater in the drying process. However, this approach is costly.

The drum type laundry machine is further adapted to heat the water for improvement of a washing capability. In this case, a great amount of water should be heated, requiring a great amount of heat. Therefore, the power consumption is considerably increased.

### SUMMARY OF THE INVENTION

In view of the foregoing, it is an object of the present invention to effectively supply steam to laundry in a drum. It is another object of the present invention to provide an arrangement for supplying steam into a drum (laundry drum) at lower costs. It is further another object of the present invention to efficiently improve a washing capability and a dewatering capability.

The present invention provides a laundry machine, which includes a steam supply port provided in one end face of a drum for supplying steam into the drum, and a steam supplying device provided in an air passage communicating with the steam supply port, the steam supplying device including a blower, a heater and means for supplying water to the heater.

The steam supplying device is allowed to double as hot air supplying device for drying laundry by controlling operation states of the blower and the water supplying means.

### BRIEF DESCRIPTION OF THE DRAWINGS

FIG. 1 is a perspective view illustrating the exterior of a drum type laundry machine according to one embodiment of the present invention;

FIG. 2 is a front vertical sectional view illustrating the internal construction of the drum type laundry machine of the embodiment;

FIG. 3 is a side vertical sectional view illustrating the internal construction of the drum type laundry machine of the embodiment;

FIG. 4 is a side view illustrating a major internal construction of the drum type laundry machine of the embodiment;

FIG. 5 is a top cross sectional view mainly illustrating a drying air passage in the drum type laundry machine of the embodiment;

FIG. 6 is an enlarged rear view illustrating in detail the structure of a dehumidification air passage in the drum type laundry machine of the embodiment;

FIG. 7 is a sectional view taken along a line A-A in FIG. 6;

FIG. 8 is a front vertical sectional view illustrating the structure of a supply port of a drum in the drum type laundry machine of the embodiment;

FIG. 9 is an electric block diagram of the drum type laundry machine;

FIG. 10 is a flow chart illustrating operations to be performed in a laundry/drying process in the drum type laundry machine of the embodiment;

FIG. 11 is a flow chart illustrating a second washing step to be performed in the laundry/drying process in the drum type laundry machine of the embodiment; and

FIG. 12 is a flow chart illustrating a drying step to be performed in the laundry/drying process in the drum type laundry machine of the embodiment.

### DETAILED DESCRIPTION OF PREFERRED EMBODIMENTS

A drum type laundry machine according to one embodiment of the present invention will hereinafter be described with reference to the attached drawings.

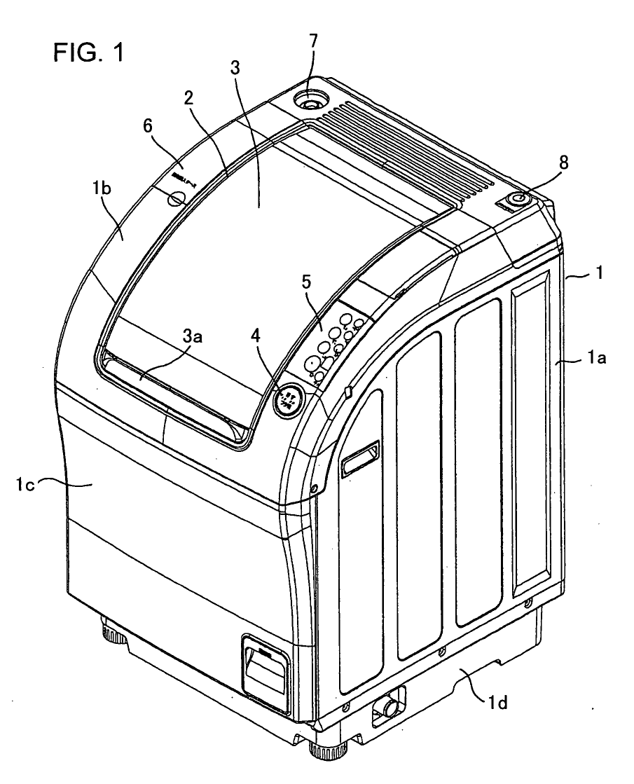

In FIG. 1, a housing 1 defining the outer shape of the drum type laundry machine includes a body 1a which has left and right side walls and a rear wall integrally formed and open front, lower and upper faces, an upper face plate 1b of a curved frame shape attached to the upper face of the body 1a, a front face plate 1c covering the front face of the body 1a and a base 1d on which the body 1a is mounted. The upper face of the body 1a is curved downward from a rear edge to a front edge thereof, and the upper face plate 1b is also curved forwardly downward.

The upper face plate 1b has a laundry loading port 2 provided in a transversely middle portion thereof as longitudinally elongated from a front edge to a rear edge thereof. The front edge of the laundry loading port 2 is located at a height of about 70 cm, for example, as measured from a floor surface, for easy loading and unloading of the laundry.

An upper lid 3 for covering and uncovering the laundry loading port 2 is slidable along the laundry loading port 2. When a user presses a lid opening button 4 provided on a right side of the laundry loading port 2 with the upper lid closed, the upper lid 3 is automatically slid rearward to uncover the laundry loading port 2. When the opened upper lid 3 is to be closed, the user pulls the upper lid 3 forward by holding a handle 3a provided on a front edge of the upper lid 3 by fingers. When the upper lid 3 is completely closed, the upper lid 3 is latched in a closed state by a latch mechanism (not shown).

An operation panel 5 is provided on the right side of the upper lid 3 as extending anteroposteriorly. Various operation keys for setting an operation mode, an appointment time and the like and various indicators which are lighted according to the setting and indicate an operation state in a laundry process, the appointment time and a process remaining time are provided in properly spaced relation on the operation panel 5. Operation keys to be used less frequently are covered with a cover which is opened rearward. A detergent container 6 covered with a cover which is opened laterally is provided on a left rear side of the upper lid 3 opposite from the operation panel 5. A tap water supply port 7 to be connected to an external water supply through a hose is provided on a rear side of the detergent container 6, and a bath water supply port 8 for supplying bath water to the laundry machine through a bathwater hose is provided on a rear side of the operation panel 5.

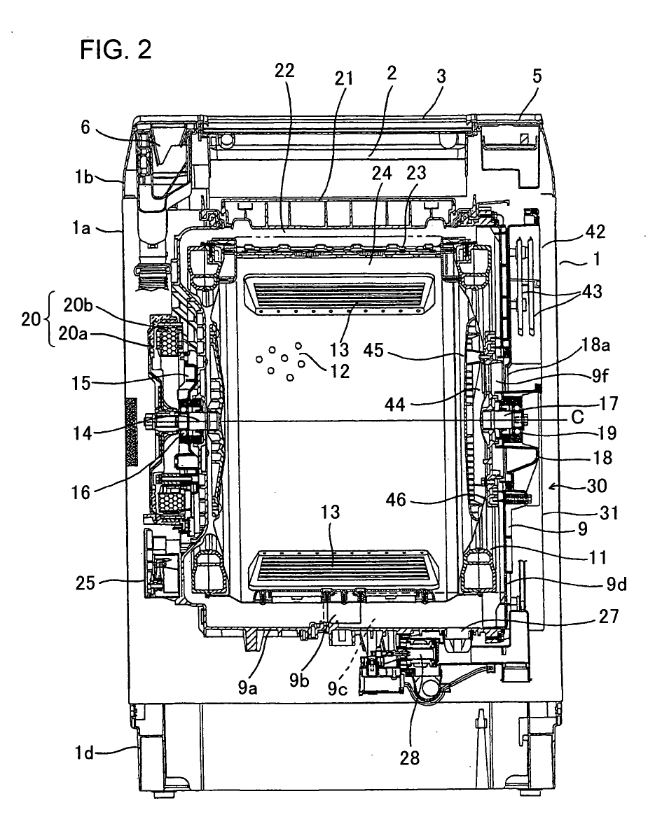

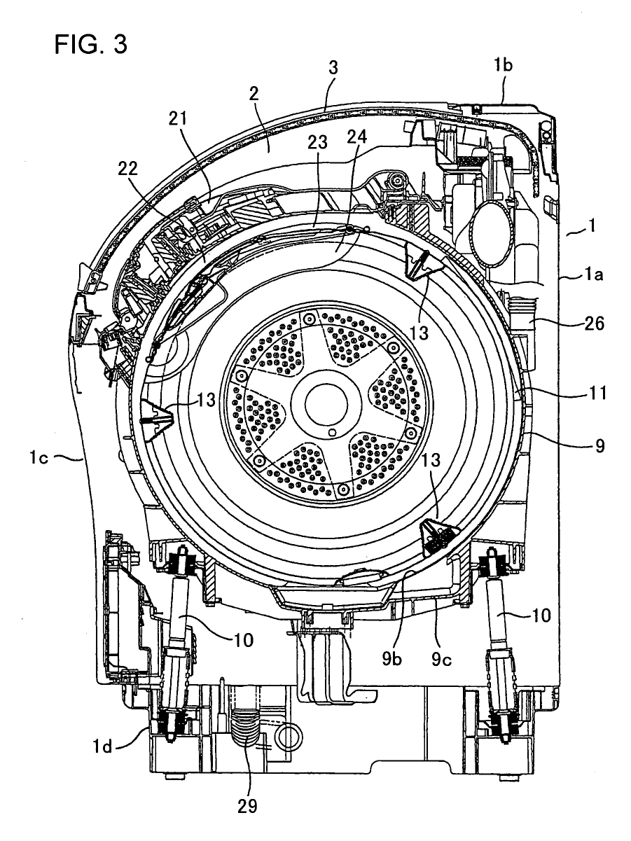

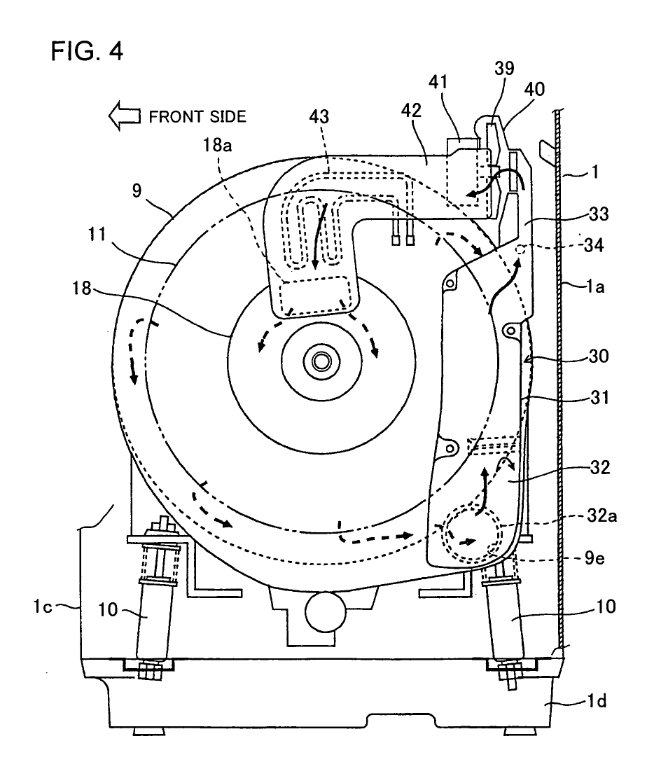

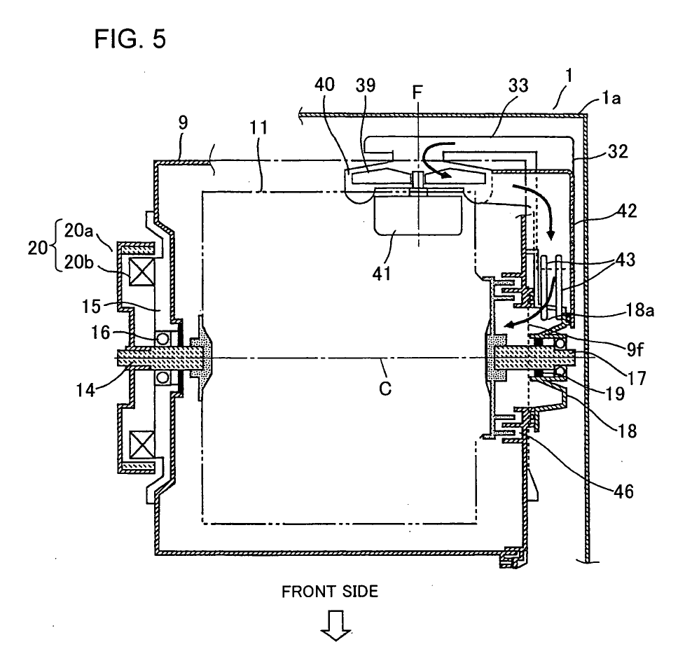

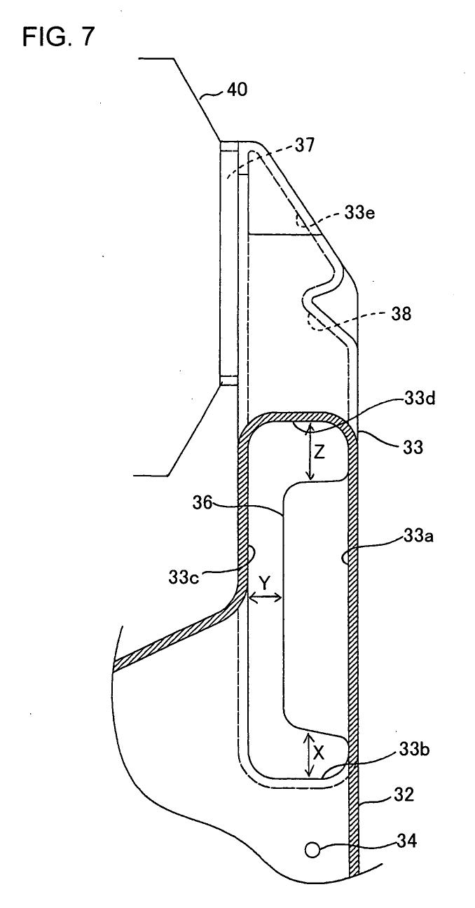

Next, the internal construction of the drum type laundry machine will be described with reference to FIGS. 2 to 8. An outer tub 9 having a generally cylindrical peripheral wall and generally closed opposite end faces are provided in the housing 1. The outer tub 9 is disposed with its end faces respectively opposed to the left and right side walls of the housing 1. The outer tub 9 is suspended at its left and right upper portions by a plurality of springs (not shown), and front and rear lower portions of the outer tub 9 are respectively supported by two dampers 10 in a moderately movable manner. A horizontal drum 11 having a generally cylindrical peripheral wall and generally closed opposite end faces and serving as an inner tub for retaining the laundry is provided in the outer tub 9 rotatably about a horizontal axis C extending laterally. The drum 11 has amultiplicity of water passage holes 12 formed in substantially the entire peripheral wall thereof except for a drum opening (to be described later). Water contained in the outer tub 9 is introduced into the drum 11 through the water passage holes 12. Further, water squeezed out of the laundry during a dewatering operation is discharged into the outer tub 9 through the water passage holes 12. Three baffles 13 for lifting the laundry are provided on an inner peripheral surface of the drum 11 in circumferentially equiangularly spaced relation (at intervals of about 120 degrees) as extending transversely and projecting inward from the inner peripheral surface of the drum 11.

A main shaft 14 fixed to the center of the left end face of the drum 11 is supported by a first bearing 16 held by a first bearing case 15 fixed to the left end face of the outer tub 10. On the other hand, an auxiliary shaft 17 fixed to the center of the right end face of the drum 11 is supported by a second bearing 19 held by a second bearing case 18 fixed to the right end face of the outer tub 9. The main shaft 14 and the auxiliary shaft 17 define the aforesaid horizontal axis C.

A rotor 20a of a DC brushless motor 20 of an outer rotor type is attached to a distal end of the main shaft 14 projecting laterally from the left end face of the outer tub 9, and a stator 20b of the motor 20 is fixed to the first bearing case 15 which doubles as a motor base. When a driving electric current is supplied to the stator 20b from a control circuit not shown, the rotor 20a is rotated by the driving electric current. Thus, the drum 11 is rotatively driven at the same rotation speed as the rotor 20a via the main shaft 14.

The outer tub 9 has an outer tub opening 22 formed in an upper portion of the peripheral wall thereof as extending obliquely forward in association with the laundry loading port 2 of the upper face plate 1b. The outer tub opening 22 is covered and uncovered with a single outer tub lid 21, which is openable rearward pivotally about an axis extending generally parallel to the horizontal axis C. The drum 11 has a drum opening 24 formed in the peripheral wall thereof. The drum opening 24 is covered and uncovered with a drum lid 23. The drum lid 23 includes two lid members that are openable away from each other anteroposteriorly pivotally about axes each extending generally parallel to the horizontal axis C.

The drum 11 is rotated within the outer tub 9. At least when the user loads or unloads the laundry in/out of the drum 11, the drum 11 should be stopped at a rotational position that radially coincides with the outer tub opening 22. To this end, a drum positioning device 25 is provided on the left end face of the outer tub 9. The drum positioning device 25 defines a drum stopping position by engagement of an engagement projection projecting from the device 25 with an engagement recess formed in the rotor 20a of the motor 20. Thus, the user can open the upper lid 3, the outer tub lid 21 and the drum lid 23 to view the inside of the drum from a diagonally upper front side for the loading and unloading of the laundry.

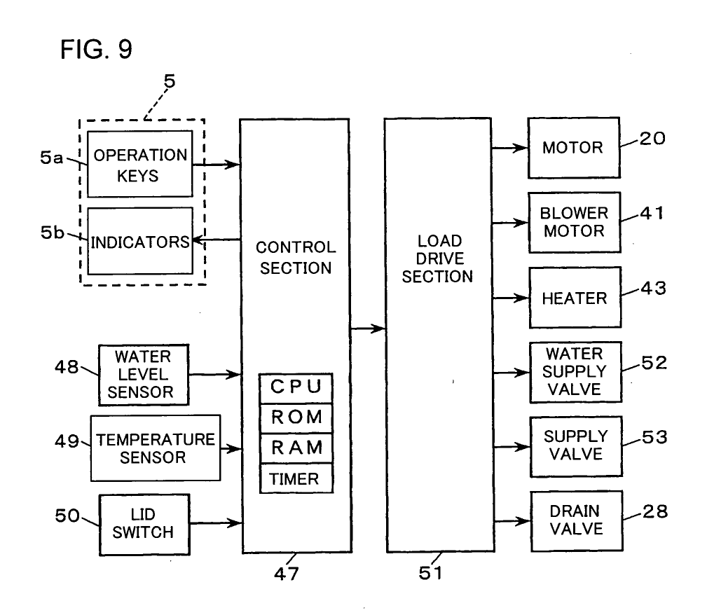

A water supply pipe 26 is connected to a rear upper portion of the outer tub 9 slightly above a vertically middle position. The water supply pipe 26 is connected to the detergent container 6. When a water supply valve 52 (see FIG. 9) is opened, water is supplied into the outer tub 9 through the detergent container 6 and the water supply pipe 26 (e.g., at a water supply rate of about 15 liters per minute). If a detergent is contained in the detergent container 6 at this time, the detergent is supplied together with the water into the outer tub 9.

A drain port 27 is provided in a lowermost portion of the outer tub 9, and connected to an external drain through a drain valve 28 and a drain hose 29. When the water is retained in the outer tub 9, the drain valve 28 is closed. When the drain valve 28 is opened, the water in the outer tub 9 is discharged out of the laundry machine through the drain port 27 and the drain hose 29.

An air circulation passage (drying air passage) 30 for circularly supplying heated drying air into the outer tub 9 during a drying process is provided between the side wall of the housing 1 and an end face portion of the outer tub 9 around the second bearing case 18 on a side of the drum 11 opposite from the motor 20. The structure of the air circulation passage 30 will be described below in detail.

The outer tub 9 includes a body 9a unitarily formed of a synthetic resin as having a generally closed left end face and an open right end face, an air outlet port 9b provided in a generally transversely middle lower portion of the body 9a as communicating with the inside of the outer tub 9, and a tubular air outlet passage 9c provided integrally with the body 9a as extending from the air outlet port 9b to the right end face of the body 9a parallel to the horizontal axis C. The air outlet port 9b serves as an exit through which air (drying air) containing moisture is discharged out of the outer tub 9 during the drying process. The air outlet passage 9c partly defines the air circulation passage.

The outer tub 9 further includes an end face member 9d covering the open right end face of the body 9a thereof. The end face member 9d has a round opening 9e in association with an open end face of the air outlet passage 9c. A dehumidification air passage 31 partly defining the air circulation passage is fixed to the end face member 9d as will be described later.

The dehumidification air passage 31 has a generally round opening 32a formed in a lower end portion thereof as facing laterally. The dehumidification air passage 31 includes an anteroposteriorly flat first air passage 32 extending generally vertically, and a laterally flat second air passage 33 formed integrally with the first air passage 32. The second air passage 33 communicates with an upper portion of the first air passage 32, and is bent upward from a laterally extending horizontal portion thereof. The dehumidification air passage 31 has a supply port 34 provided at a position thereof slightly lower than a junction between the first air passage 32 and the second air passage 33, and a cooling water supply pipe 35 is connected to the supply port 34. The supply pipe 35 is connected to a cooling water supply valve 53 and, when the supply valve 53 is opened, cooling water (tap water) flows into the first air passage 32 through the supply pipe 35 (e.g., at a water supply rate of about 0.5 liters per minute). Thus, the first air passage 32 serves as a heat exchanger for cooling the drying air containing moisture to condense the moisture into water.

The dehumidification air passage 31 is attached to the outer tub 9 with its opening 32a engaged with the opening 9e of the outer tub 9. The first air passage 32 is disposed in a space defined between the right end face of the outer tub 9 and the right side wall of the housing 1, and the second air passage 33 is disposed in a space defined between a rear portion of the body 9a of the outer tub 9 and the rear wall of the housing 1.

The second air passage 33 has a projection 36 provided adjacent to an inlet end thereof as projecting inward from a rear interior surface 33a thereof. The projection 36 extends vertically and has a chevron shape in cross section. The projection 36 is disposed so that clearances X, Y, Z are respectively defined between the projection 36 and a lower interior surface 33b, a front interior surface 33c and an upper interior surface 33d of the second air passage 33. The projection 36 narrows a downstream portion of the air passage adjacent to the supply port 34.

The second air passage 33 has an outlet opening 37 formed in an outlet end thereof as facing forward. Further, an upper interior surface 33e of the second air passage 33 is inclined rearwardly downward so that the air flowing into the second air passage 33 is easily directed toward the outlet opening 37. A projection 38 (a barrier in the present invention) of a generally chevron shape in cross section is provided on a boundary between the rear interior surface 33a and the inclined surface 33e of the second air passage 33 as projecting inward and extending laterally and generally horizontally. The projection 38 has aright end portion extending to a right side wall of the second air passage 33, and a left end portion spaced a predetermine distance from a left side wall of the second air passage 33.

The outlet opening 37 of the second air passage 33 is connected to a rear portion of a blower chamber 40 in which a blower 39 is provided. A blower motor 41 is disposed in front of the blower chamber 40, i.e., on an upper rear side of the outer tub 9 on a side of the blower chamber 40 opposite from the rear wall of the housing 1, with an axis F of a motor shaft thereof extending horizontally and generally perpendicularly to the horizontal axis C. The motor shaft of the blower motor 41 is directly connected to the blower 39.

A heater housing 42 which partly defines the air circulation passage is connected to a right side of the blower chamber 40. The heater housing 42 extends generally horizontally, and is bent generally perpendicularly forward at the outside of the right end face of the outer tub 9 and then generally perpendicularly downward above the auxiliary shaft 18. A heater 43 including two sheathed line heaters is provided in the heater housing 42 for heating air passing through the heater housing 42. By energizing one of the sheathed line heaters, the heater 43 is driven at a low level (e.g., at about 700 W). By energizing both of the sheathed line heaters, the heater 43 is driven at a high level (e.g., at about 1400 W). By energizing both of the sheathed line heaters and performing a half-wave control on an alternating current flowing through one of the sheathed line heaters (for allowing the alternating current to flow through the one sheathed line heater in a half cycle), the heater 43 is driven at an intermediate level (e.g., at about 1000 W).

An air inlet port 9f for introducing the drying air into the outer tub 9 is provided in a portion of the end face member 9d of the outer tub 9 covered with the second bearing case 18. The heater housing 42 communicates with the inside of the outer tub 9 via an opening 18a of the second bearing case 18 and the air inlet port 9f of the outer tub 9.

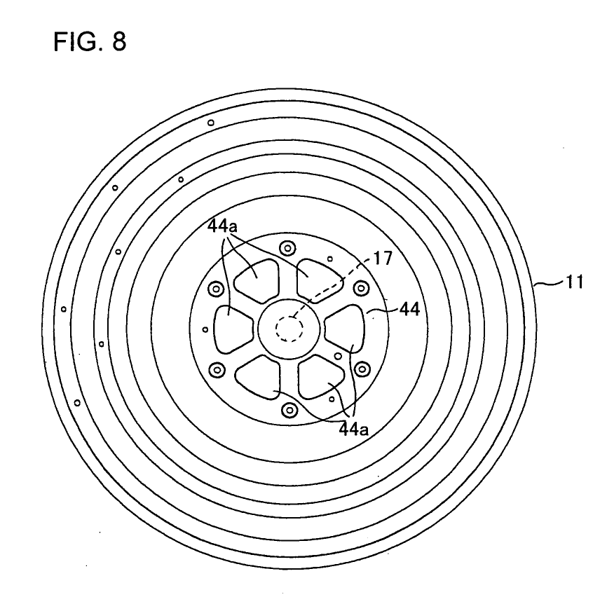

An air blowing port 44 is provided in a center portion of the right end face of the drum 11 in opposed relation to the air inlet port 9f of the outer tub 9. The air blowing port 44 includes a plurality of openings 44a provided radially around the auxiliary shaft 17 as shown in FIG. 8. These openings 44a are sufficiently greater in size than the water passage holes 12 provided in the peripheral wall of the drum 11. The air blowing port 44 is covered with an air blowing port cover 45 provided in front of the air blowing port 44. The air blowing port cover 45 has air passage holes, which are sufficiently greater in size than the water passage holes 12. A space between the air inlet port 9f and the air blowing port 44 are sealed with a non-contact type seal 46 including a plurality of annular ribs provided on the side of the outer tub 9 and a plurality of annular ribs provided on the side of the drum 11 (a labyrinth seal with the annular ribs on one side and the annular ribs on the other side being arranged in staggered relation). Thus, the drying air and steam (to be described later) are less liable to leak into the space between the drum 11 and the outer tub 9.

FIG. 9 is an electrical block diagram of the drum type laundry machine. A control section 47 principally includes a microprocessor including a CPU, a ROM, a RAM, a timer and the like. The control section 47 performs various control operations for laundry-related operation processes to be described later. The control section 47 is connected to the operation keys 5a, the indicators 5b, a water level sensor 48 for detecting the water level of the water retained in the outer tub 9, a temperature sensor 49 for detecting the temperature of the air flowing out of the outer tub 9 through the air outlet port 9b, a lid switch 50 for detecting the opening and closing of the upper lid 3, and the like. The control section 47 is further connected to a load drive section 51. The control section 47 controls the operations of the motor 20, the blower motor 41, the heater 43, the water supply valve 52, the supply valve 53, the drain valve 28 and the like through the load drive section 51.

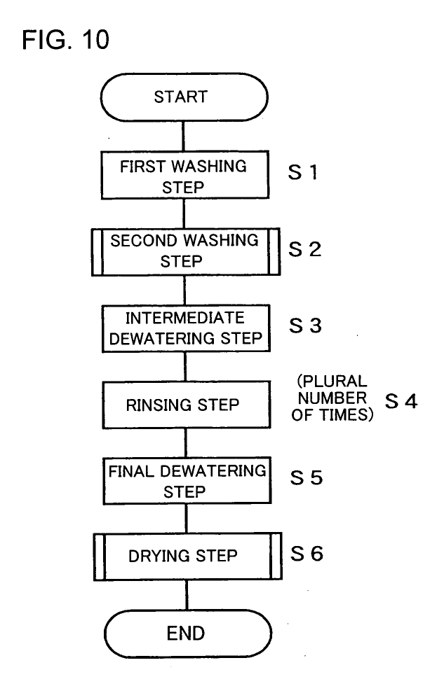

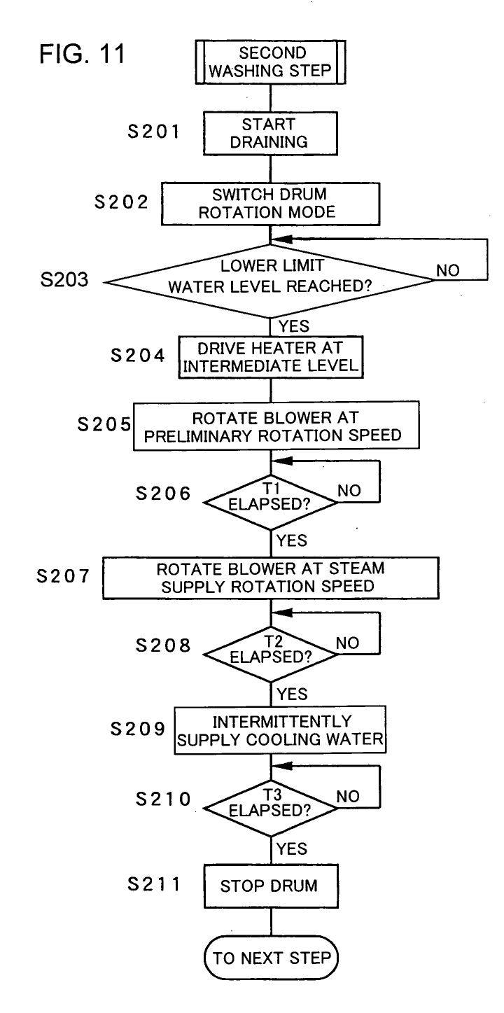

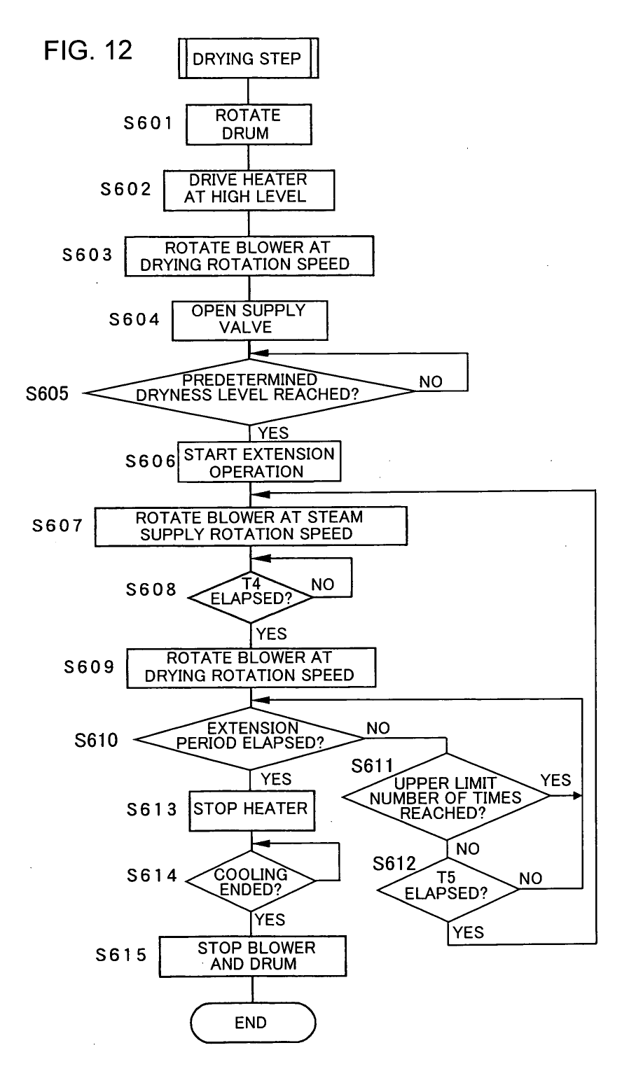

Next, one exemplary operation process to be performed by the drum type laundry machine having the aforesaid construction will be described with reference to flow charts shown in FIGS. 10 to 12. The operation process to be herein explained is a standard automatic operation process for continuously performing operations from the start of the laundry process to the end of the drying process. The drum type laundry machine is characterized by a steam washing operation for washing the laundry while supplying steam into the drum 11 in a washing step, and a laundry finishing operation for supplying steam into the drum 11 which contains the laundry substantially completely dried at the last stage of a heat drying step in the drying process. The supply of the steam into the drum 11 is achieved by controlling the heater 43, the blower motor 41 and the supply valve 53 in a manner different from an ordinary heat drying operation.

First, the user opens the upper lid 3, and then opens the outer tub lid 21 and the drum lid 23 to load the laundry in the drum 11. Further, the user puts a detergent and a softening agent in the detergent container 6. When the user performs a starting operation by operating the operation panel 5, the control section 47 starts the operation process according to the operation of the operation panel 5. The control section 47 first performs a first washing step (Step S1). The control section 47 opens the water supply valve 52 to supply water into the outer tub 9. At this time, the drain valve 28 is closed, so that detergent water in which the detergent contained in the detergent container 6 is dissolved is retained in the outer tub 9. The water retained in the outer tub 9 flows into the drum 11 through the water passage holes 12 and the like, so that the laundry is soaked in the detergent water.

When a predetermined water level is reached, the control section 47 drives the motor 20 at a predetermined rotation speed (e.g., 45 rpm) in opposite directions (e.g., ON for 10 seconds and OFF for 3 seconds). The laundry in the drum 11 is lifted by the baffles 13 and dropped from an upper side thereby to be beat-washed. After the beat-washing operation is performed for a predetermined period (e.g., 6 minutes), a second washing step is started.

When the second washing step is started (Step S2) the control section 47 opens the drain valve 28 to start draining the water from the drum 11 (Step S201) and switches the rotative driving state (mode) of the drum 11 (Step S202). More specifically, the second washing step is performed in the same ON-OFF cycle as the first washing step, but the rotation speed of the drum 11 is changed with time. The drum 11 is first rotated for a predetermined period (e.g., 3 minutes) at a first rotation speed which is the same rotation speed as in the first washing step for tumbling the laundry, and then rotated for a predetermined period (e.g., 30 seconds) at a predetermined second rotation speed (e.g., 30 rpm) such that the laundry is tumbled only in a bottom portion of the drum 11. After the drum 11 is rotated at the first rotation speed for the aforesaid predetermined period, the drum 11 is further rotated for a predetermined period (e.g., 30 seconds) at a third rotation speed (e.g., 60 rpm) such that the laundry lightly adheres to the interior surface of the drum 11. This operation is repeatedly performed. The laundry is beat-washed by the rotation at the first rotation speed, and rub-washed by the rotation at the second rotation speed. By the rotation at the third rotation speed, a dewater-washing operation is performed for squeezing the detergent water together with dirt out of the laundry by a centrifugal force.

When the retained water is discharged to a predetermined water level (lower limit water level) with the air outlet port 9b at the lower portion of the outer tub 9 opened (not closed by the water) (Step S203), the control section 47 drives the heater 43 at the intermediate level (Step S204) and rotatively drives the blower motor 41 at a preliminary rotation speed (e.g., 3400 rpm) (Step S205). The preliminary rotation speed is lower than a rotation speed (e.g., 4500 rpm) employed for the heat drying operation in the drying process to be described later, and permits speedy increase of the temperature of the heater 43. The intensity of the heater 43 is adjusted at the intermediate level for the following reason. The laundry in the drum 11 is relatively heavy because it absorbs a great amount of water. Therefore, when the laundry is tumbled, a driving electric current required for the driving of the motor 20 is increased unlike in the drying process. If the heater 43 was driven at the high level, the electric current consumption of the overall laundry machine would exceed the rated current of the laundry machine. The blower 39 is thus rotated to generate air streams, which are circulated through the outer tub 9, the drum 11 and the air circulation passage 30.

When the temperature of the heater 43 is sufficiently increased with the water level in the outer tub 9 lowered below the bottom of the drum 11 after a lapse of a predetermined period T1 (e.g., 4 minutes) from the start of the draining of the water (Step S206), the control section 47 increases the rotation speed of the blower motor 41 to a level (hereinafter referred to as “steam supply rotation speed”) which is set higher than the rotation speed for the heat drying operation (hereinafter referred to as “drying rotation speed”) (Step S207). When the rotation speed of the blower motor 41 reaches the steam supply rotation speed after a lapse of a predetermined period T2 (e.g., 1 minute) (Step S208), the supply valve 53 is opened to supply cooling water into the first air passage 32 from the supply port 34 (Step S209). During the supply of the cooling water, the control section 47 intermittently opens the supply valve 53. For example, an intermittent valve opening operation in a 10-second ON/110-second OFF cycle is repeated three times.

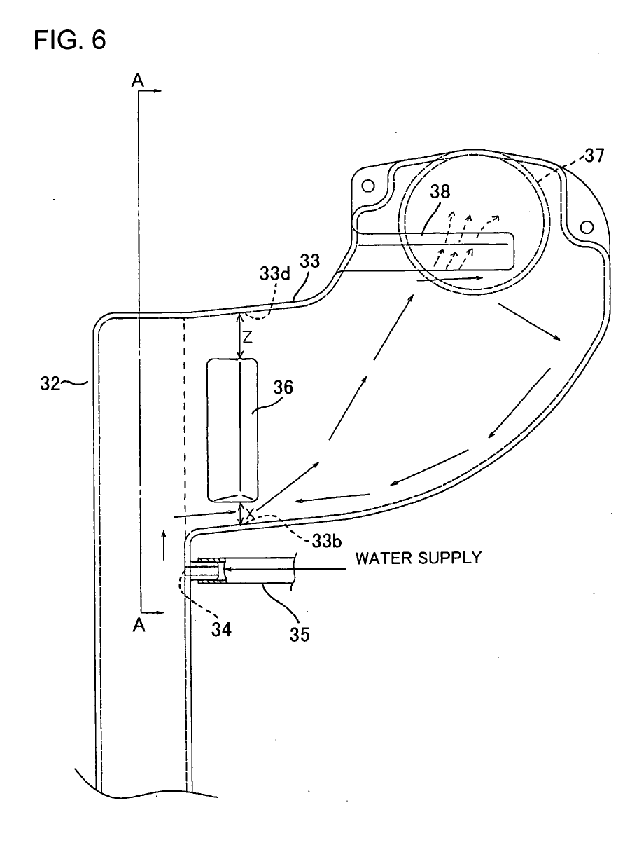

The cooling water flowing into the first air passage 32 through the supply port 34 does not flow downward (upstream) but is mostly sucked upward into the second air passage 33. This is because the rotation speed of the blower motor 41 is higher than the drying rotation speed to provide higher speed air streams (higher blowing power), and the air passage is narrowed downstream of the supply port 34 by the projection 36 to further increase the flow rate of the air streams in the vicinity of the supply port 34. The cooling water thus flowing into the second air passage 33 mostly flows through the clearance X between the projection 36 and the lower interior surface 33b of the second air passage 33 and then upward in the air passage 33, and is finely disintegrated into water droplets which are in turn directed toward the outlet opening 37 (as indicated by solid line arrows in FIG. 6). Then, the cooling water (water droplets) is partly introduced into the blower chamber 40 through the outlet opening 37 (as indicated by broken line arrows in FIG. 6). On the other hand, a part of the water flowing upward in the vicinity of the rear interior surface 33a of the second air passage 33 hits against the projection 38 disposed at the outlet end thereby to be prevented from further flowing upward, and loses momentum. Then, the water flows back to the exit of the clearance X defined by the projection 36 along the lower interior surface 33b of the second air passage 33 (as indicated by solid line arrows in FIG. 6), and are borne on water-containing air streams swiftly flowing out of the clearance X toward the outlet opening 37. Thus, the water flowing into the second air passage 33 does not entirely flow into the blower chamber 40, but is partly circulated in the air passage 33 as described above and then moderately flows into the blower chamber 40.

The water droplets introduced into the blower chamber 40 are further borne on the air streams to flow into the heater housing 42. In the heater housing 42, the water droplets are brought in contact with the heater 43 to be evaporated into steam. The steam thus generated is borne on the air streams, and flows through the air inlet port 9f to be blown into the drum 11 from the air blowing port 44. As described above, since the supply valve 53 is intermittently opened during the supply of the cooling water, the water supply is periodically stopped. However, as the water circulates in the second air passage 33 during this period, the water droplets gradually flow into the blower chamber 40 and then to the heater 43. Therefore, the steam is continuously generated, though the amount of the generated steam is gradually reduced. Hence, the steam is continuously supplied into the drum 11 during the supply of the cooling water (for 6 minutes in this embodiment).

The laundry absorbing the detergent water and still subjected to the washing operation after the water is discharged out of the drum 11 is heated by the steam introduced into the drum 11. Thus, the temperature of the laundry is increased. The supply amount and the supply period of the steam, which may vary depending on the ambient temperature and the initial temperature of the detergent water absorbed in the laundry, are determined so that the temperature of the laundry can be increased to about 40° C. during the washing operation with the supply of the steam in this drum type laundry machine.

Greasy dirt which is not completely washed off due to a lower water temperature during the first washing step is more easily lifted off by increasing the temperature of the laundry by the steam. Further, the activity of an enzyme contained in the detergent remaining in the laundry is increased. Thus, persistent stain such as of greasy dirt is washed off by various washing operations including the beat-washing operation, the rub-washing operation and the dewater-washing operation. At this time, the drain valve 28 is opened, and the dirt thus washed off is discharged together with the detergent water out of the laundry machine.

After the supply of the steam is stopped at the end of the cooling water supply period, the washing operation performed by the rotation of the drum 11 is continued for awhile. After a lapse of a predetermined period T3 (e.g., 14 minutes) from the start of the second washing step (Step S210), the control section 47 stops the drum 11 (Step S211) to end the second washing step, and starts an intermediate dewatering step.

In the intermediate dewatering step, the drum 11 is rotated at a high speed (e.g., 1000 rpm) to squeeze the detergent water out of the laundry (Step S3). The water squeezed out of the laundry is discharged into the outer tub 9 through the water passage holes 12 and then out of the laundry machine through the drain hose 29.

After the completion of the intermediate dewatering step, a rinsing step is performed for beat-rinsing the laundry while rotating the drum 11 at a lower rotation speed with a predetermined amount of water retained in the drum 11 as in the first washing step, followed by the intermediate dewatering step. This operation is repeated a plurality of times (e.g., twice) (Step S4). Then, a final dewatering step is performed to dewater the laundry as in the intermediate dewatering step (Step S5). A dewatering period for the final dewatering step is sufficiently longer than that for the intermediate dewatering step so as to provide a satisfactory dewatering efficiency.

Upon the completion of the final dewatering step, the drying process is started (Step S6). The control section 47 rotatively drives the drum 11 (Step S601), and drives the heater 43 and the blower motor 41 (Steps S602, S603). Further, the control section 47 opens the supply valve 53 (Step S604). Thus, the heat drying operation is started for drying the laundry by hot drying air. In the heat drying operation, the rotation speed of the blower motor 41 is set at the aforesaid drying rotation speed (e.g., 4500 rpm), and the intensity of the heater 43 is set at the high level.

When the blower 39 is rotatively driven by the blower motor 41, the blower 39 laterally blows the air sucked from the rear side thereof. Therefore, drying air streams directed from the blower chamber 40 to the heater housing 42 are generated, and heated by the heater 43 when passing through the heater housing 42. The resulting hot drying air flows into the drum 11 from the air blowing port 44 through the air inlet port 9f. The drying air flowing into the drum 11 passes through gaps between pieces of the laundry and gaps between fibers of the laundry thereby to remove moisture from the laundry. Then, the drying air sufficiently containing moisture mainly flows out of the drum 11 through the water passage holes 12, and is directed toward the air outlet port 9b through the space defined between the drum 1 and the outer tub 9. The drying air discharged out of the outer tub 9 through the air outlet port 9b and containing a great amount of moisture reaches the dehumidification air passage 31 through the air outlet passage 9c and flows upward in the first air passage 32.

The cooling water supplied into the first air passage 32 mostly flows down into the first air passage 32 because the rotation speed of the blower 39 at this time does not provide an air flow rate sufficient to suck the water upward. That is, the cooling water flows in a direction opposite to the direction of the drying air flowing in the first air passage 32. The humid drying air is rapidly cooled by heat exchange with the cooling water. As a result, the moisture contained in the drying air is condensed into water on the interior surface of the first air passage 32, and the water flows down along the interior surface of the first air passage 32. Therefore, the drying air is dehumidified while passing through the first air passage 32, and the resulting dry air flows back into the blower chamber 40 through the second air passage 33. Then, the drying air is introduced again into the heater housing 42 by the blower 39 thereby to be heated again by the heater 43.

The water condensed on the interior surface of the first air passage 32 flows together with the cooling water into the air outlet passage 9c from the opening 9e, and then flows into the outer tub 9 along the moderate inclination of the bottom of the air outlet passage 9c. Finally, the water is discharged out of the laundry machine through the drain port 27.

A very small amount of the cooling water supplied into the first air passage 32 may be sucked into the second air passage 33. In this case, the cooling water sucked into the second air passage 33 is directed toward the outlet opening 37 along the rear interior surface 33a of the second air passage 33, though the air streams do not have sufficient momentum. However, the water (water droplets) flowing upward is blocked by the projection 38 which is disposed at the outlet end of the second air passage 33. Therefore, the water is prevented from flowing into the blower chamber 40.

The temperature of the air discharged from the air outlet port 9b is kept generally constant when heat is sufficiently exchanged between the wet laundry and the hot drying air in the drum 11, but increased when the laundry becomes dry and the heat exchange does not sufficiently occur. Therefore, the control section 47 judges the dryness level of the laundry on the basis of the discharged air temperature detected by the temperature sensor 49. When the control section 47 determines that the laundry dryness level reaches a predetermined level (Step S605) the heat drying operation is further continued for an extension period which is determined according to an automatic operation period required for reaching the predetermined dryness level (Step S606). When the automatic operation period is longer, it is supposed that a greater amount of laundry is present in the drum 11 and, therefore, the extension period is set longer.

When the process enters the extension period, the control section 47 increases the rotation speed of the blower motor 41 from the drying rotation speed to the steam supply rotation speed for a predetermined period T4 (e.g., 20 seconds), while keeping the output of the heater 43 at the high level (Steps S607 to S609). Thus, the water droplets in a mist form are carried into the heater 43, and heated by the heater 43 for the generation of the steam, which is introduced into the drum 11. Thus, the steam is applied to the dried laundry in the drum 11, whereby the laundry is unwrinkled and softened with fibers thereof raised. Further, static electricity is suppressed.

If the extension period is relatively long, the supply of the steam is repeated up to an upper limit number of times (e.g., three times at the maximum) during a predetermined period T5 (e.g., 2 minutes) (steps S610 to S612). Where the extension period is set to 4 minutes, 8 minutes or 15 minutes, for example, the supply of the steam occurs once in an extension period of 4 minutes, twice in 8 minutes, and three times in 15 minutes. This is because the extension period is set longer when the amount of the laundry is great and, in this case, the number of times for the finishing of the laundry with the steam is preferably increased.

After a lapse of the extension period (YES in Step S610), the control section 47 stops the heater 43 to end the heat drying operation (Step S613). After a cooling operation is performed for cooling the laundry only by supplying air from the blower 39, the control section 47 stops the blower 39 and the drum 11 to end the drying process (Steps S614, S615). Thus, the laundry/drying process is completed.

As described above, the drum type laundry machine performs the first washing step for washing the laundry in the detergent water contained in the drum 11 and, after the water is drained out of the drum 11, performs the second washing step for washing the laundry absorbing the detergent water while warming the laundry by the steam. Therefore, the drum type laundry machine has an improved washing capability. In addition, a relatively small amount of the detergent water absorbed in the laundry after the draining of the water is warmed by the effect of the steam without the need for a great amount of heat. Consequently, the washing capability can be improved with reduced power consumption.

The steam is generated by utilizing the air blowing means (the blower 39 and the blower motor 41) and the heating means (the heater 43) which are originally provided for heat-drying the laundry, and the cooling water supplying means (the supply valve 53 and the supply pipe 35). Therefore, the arrangement for the generation of the steam can be provided at lower costs.

Further, the steam is introduced into the drum 11 not through the small water passage holes 12 provided in the peripheral wall of the drum 11 but through the dry air blowing port 44 which is provided in the one end face of the drum 11 and is greater in size than the water passage holes 12. Therefore, the steam can be sufficiently supplied into the drum 11. Further, the steam is blown into the drum 11 from the center portion of the one end face of the drum 11, so that the steam can be evenly applied to the laundry tumbled in the drum 11.

In the second washing step in which the steam is supplied for a relatively long period, the cooling water is intermittently supplied for the supply of the steam. This prevents a steam generation failure which may otherwise occur when a great amount of water (water droplets) is continuously applied to the heater 43 to reduce the temperature of the heater 43.

Further, the projection 36 is provided downstream of the cooling water supply port 34 in the vicinity of the cooling water supply port 34 to narrow the air passage, whereby the flow rate of the air is increased in the vicinity of the supply port 34. Thus, the water flowing through the supply port 34 can be easily sucked into the downstream second air passage 33 during the generation of the steam. Therefore, the water can be supplied to the heater 43 without the need for extremely increasing the blowing power of the blower 39.

The projection 38 is disposed in the vicinity of the outlet opening 37 of the second air passage 33. Therefore, even if the cooling water is partly supplied to the downstream second air passage 33 during the ordinary heat drying operation, the cooling water is blocked by the projection 38. Thus, the water is prevented from being supplied to the heater 43 when unnecessary. Since the amount of the water directed toward the heater 43 can be properly adjusted by the projection 38, it is possible to prevent the supply of a great amount of water to the heater 43 at a time and hence to prevent the reduction in the temperature of the heater 43.

If the clearances Y, Z defined between the projection 36 and the interior surfaces of the air passage are too large, a greater amount of air is introduced through the clearances Y, Z, and the flow rate of the air flowing through the clearance X is reduced. This reduces a suction force for sucking the cooling water into the second air passage 33 during the supply of the steam. On the other hand, if the clearances Y, Z are too small, it is impossible to supply a sufficient amount of air during the ordinary heat drying operation, thereby reducing the drying capability. In view of this, the clearances Y and Z are experimentally determined so as not to reduce the cooling water suction force and the drying capability. If the clearance X is changed, the direction of the water flowing out of the clearance X during the supply of the steam is changed. Further, the flow rate is also changed. In view of this, the clearance X is experimentally determined so as to provide a flow rate sufficient to properly direct the water toward the outlet opening 37.

In the embodiment described above, the dewatering step is started immediately after the completion of the rinsing step. Alternatively, a steam heating step for warming the laundry by supplying the steam into the drum 11 while rotating the drum 11 may be performed at least before the start of the final dewatering step after the water is drained out of the drum 11.

With this arrangement, the dewatering operation can be performed after the temperature of the laundry is increased upon the completion of the rinsing step. Therefore, the water more easily permeates the laundry, and the dewatering capability is improved. In addition, a relatively small amount of water absorbed in the laundry after the draining of the water is warmed by the effect of the steam without the need for a great amount of heat. Therefore, power consumption can be reduced.

The embodiment described above is merely an example of the present invention and, apparently, modifications and alterations may be made within the scope of the present invention. In the embodiment described above, the present invention is applied to the drum type laundry machine, but is applicable to a laundry machine which includes a cylindrical laundry/dewatering tub having a closed bottom and rotatable about a vertical axis or an axis inclined with respect to the vertical axis. Further, the present invention is applicable to a laundry machine which does not have a hot air drying function.

This application corresponds to Japanese Patent Application No. 2004-142873 filed with the Japanese Patent Office on May 12, 2004, the disclosure of which is incorporated herein by reference.

What is claimed is:

1. A laundry machine comprising:
a housing;
an outer tub supported in the housing;
a drum of a horizontal axis type rotatably provided in the outer tub and having a peripheral wall and opposite end faces;
a multiplicity of water passage holes formed in the peripheral wall of the drum;
a steam blowing port provided in one of the end faces of the drum; and
steam supplying means which supplies steam into the drum through the steam blowing port.

2. A laundry machine as set forth in claim 1, wherein the drum has an opening formed in the peripheral wall thereof for loading and unloading laundry.

3. A laundry machine as set forth in claim 1, further comprising:
first washing step performing means which performs a first washing step for washing laundry by retaining detergent-containing water (detergent water) up to a predetermined water level in the drum and then rotating the drum for stirring the laundry in the drum; and
second washing step performing means which performs a second washing step after the first washing step by supplying the steam into the drum by the steam supplying means to increase a temperature of the laundry in the drum after draining the detergent water out of the drum and, in this state, rotating the drum for stirring the laundry in the drum.

4. A laundry machine as set forth in claim 1, further comprising:
rinsing step performing means which performs a rinsing step for rinsing laundry by retaining rinsing water up to a predetermined water level in the drum and rotating the drum for stirring the laundry in the drum;
steam heating step performing means which performs a steam heating step after the rinsing step by supplying the steam into the drum by the steam supplying means to increase a temperature of the laundry by the steam after draining the rinsing water out of the drum; and
dewatering step performing means which performs a dewatering step for dewatering the laundry by high speed rotation of the drum after the steam heating step.

5. A laundry machine as set forth in claim 1, wherein the steam supplying means comprises:
an air passage communicating with the steam blowing port provided in the one end face of the drum;
air blowing means disposed in the air passage for supplying air to the steam blowing port;
heating means provided in the air passage for heating the air to be supplied into the air passage; and
water supplying means which supplies water to an upstream side of the heating means in the air passage.

6. A laundry machine as set forth in claim 5, wherein the air passage communicates with the outer tub at one end thereof and communicates with the steam blowing port at the other end thereof, and includes an air circulation passage through which the air in the drum is taken out of the outer tub and supplied back into the drum.

7. A laundry machine as set forth in claim 6, wherein the steam blowing port doubles as hot air blowing port for blowing hot air during a drying operation.

8. A laundry machine as set forth in claim 7, wherein the air blowing means and the heating means function as hot air supplying means for supplying hot drying air into the drum during the drying operation.

9. A laundry machine as set forth in claim 7, wherein the water supplying means functions as heat exchange water supplying means for dehumidifying humid air discharged from the outer tub by heat exchange with the humid air during the drying operation.

10. A laundry machine comprising:
a housing;
a laundry tub disposed in the housing for retaining laundry for washing and drying the laundry;
a drying air passage for introducing drying air into the laundry tub for drying the laundry in the laundry tub;
air blowing means disposed in the drying air passage for supplying the drying air into the laundry tub;
heating means disposed in the drying air passage for heating the drying air to be supplied into the laundry tub;
water supplying means for supplying water to an upstream side of the heating means; and
steam supply controlling means which actuates the air blowing means, the heating means and the water supplying means for supplying the water introduced into the drying air passage to the heating means, then heating the water by the heating means to generate steam, and supplying the steam into the laundry tub.

11. A laundry machine as set forth in claim 10,
wherein the laundry tub has a drying air inlet port and an drying air outlet port,
wherein the drying air passage includes an air circulation passage disposed outside the laundry tub as communicating with the air inlet port and the air outlet port.

12. A laundry machine as set forth in claim 11, wherein the steam supply controlling means controls the air blowing means so as to provide greater air blowing power during the generation of the steam than during an ordinary drying operation.

13. A laundry machine as set forth in claim 12, wherein the steam supply controlling means intermittently actuates the air supplying means.

14. A laundry machine as set forth in claim 12, wherein the air circulation passage has a narrow portion provided therein downstream of a water supply port through which the water is supplied from the water supplying means, so that an air flow rate is increased in the vicinity of the water supply port.

15. A laundry machine as set forth in claim 12, wherein the air circulation passage has a barrier for blocking unnecessary water directed toward the air blowing means and the heating means.

16. A laundry machine comprising:
a housing;
an outer tub supported in the housing;
a drum of a horizontal axis type rotatably disposed in the outer tub;
a multiplicity of water passage holes formed in a peripheral wall of the drum;
a drum opening formed in the peripheral wall of the drum for loading and unloading laundry;
a drum lid for covering and uncovering the drum opening;
a drying air blowing port provided in a center portion of one end face of the drum;
a drying air inlet port and a drying air outlet port provided on the outer tub;
an air circulation passage provided outside the outer tub and communicating with the air inlet port and the air outlet port;
air blowing means disposed in the air circulation passage for supplying drying air into the drum;
heating means disposed in the air circulation passage for heating the drying air to be supplied into the drum;
cooling water supplying means for introducing cooling water into the air circulation passage on an upstream side of the air blowing means and the heating means to dehumidify the drying air discharged from the outer tub by heat exchange with the drying air; and
steam supply controlling means which actuates the heating means and the cooling water supplying means and actuates the air blowing means so as to provide greater air blowing power than in an ordinary heating operation for supplying the water introduced into the air circulation passage to the heating means, then heating the water by the heating means to generate steam, and supplying the steam into the drum through the blowing port.

17. A laundry machine as set forth in claim 16, wherein the steam supply controlling means intermittently actuates the cooling water supplying means.

18. A laundry machine as set forth in claim 16, wherein the air circulation passage has a narrow portion provided therein downstream of a cooling water supply port through which the water is supplied from the cooling water supplying means, so that an air flow rate is increased in the vicinity of the cooling water supply port.

19. A laundry machine as set forth in claim 16, wherein the air circulation passage has a barrier for blocking unnecessary cooling water directed toward the air blowing means and the heating means.
